(19) United States
(12) Patent Application Publication
(10) Pub. No.: US 2006/0156512 A1
(43) Pub. Date: Jul. 20, 2006

(54) Single axis hinge

(76) Inventor: Francis Naylor, Warrington (GB)

Correspondence Address: Gauthier & Connors LLP, Suite 2300, 225 Franklin Street, Boston, MA, 02110, US

(21) Appl. No.: 11/377,830

(22) Filed: Mar. 16, 2006

Related U.S. Application Data
(63) Continuation of application No. PCT/GB04/03977, filed on Sep. 17, 2004.

(30) Foreign Application Priority Data
Sep. 17, 2003 (GB) 0321752.8

(51) Int. Cl. E05D 11/00

(52) U.S. Cl. 16/273

(57) ABSTRACT

A single axis hinge comprising a pair of leaves (10, 11), one for attachment to a door and the other to a door frame, the leaves having respective tubular knuckles (12, 13) which are axially aligned in the assembled hinge and which receive at least one hinge pin (16, 17) to form a pivotal journal between the respective knuckles. The knuckles and pins are assembled, with annular bushes (15), such that in use, an axial load applied to the hinge is supported in part by the or each hinge pin and in part by the face-to-face abutment of the leaf knuckles. The interengaging and relatively movable parts may be coated by a low friction high wear resistant solid lubricant carbon material.

This invention concerns a single axis hinge which comprises a pair of leaves one for attachment to a door and the other to a door frame upon which the door is to be hung, the leaves having respective tubular knuckles which are axially aligned between the leaves in the assembled hinge and which receive at least one hinge pin forming a pivotal journal between the respective knuckles and the leaves.

Conventionally, such hinges are constructed such that the axial load imposed by one hinge leaf on the other is borne by the face-to-face abutment of the respective knuckles. For this purpose, the performance of the hinge may be enhanced by incorporating washers, bushes or ball bearings between the abutting faces of the respective knuckles.

In an alternative conventional arrangement, a pair of aligned pins are provided extending axially through the knuckles and each attached to one of the knuckles, the pins having end-to-end bearing faces within the hinge to provide the axial support.

In both of these conventional arrangements, gradual wear of the bearing faces in use will often cause the hinge to bind or become sloppy such that its performance is reduced.

It is an object of the present invention to provide a single axis hinge wherein the aforementioned problems of wear are substantially alleviated.

According to the present invention, there is provided a single axis hinge comprising a pair of leaves one for attachment to a door and the other to a door frame upon which the door is to be hung, the leaves having respective tubular knuckles which are axially aligned in the assembled hinge and which receive at least one hinge pin forming a pivotal journal between the respective knuckles; characterised in that the assembly of the or each pin and the knuckles is such that an axial load applied to the hinge where the door is hung thereon is supported in part by the or each hinge pin and in part by a face-to-face abutment of the leaf knuckles.

At least one annular bush may be interposed between abutting faces of the leaf knuckles.

The bush may have a cylindrical part to be inserted into at least one of the leaf knuckles.

The bush may be a blind bush recessed axially to provide a seat for an end of a hinge pin.

The blind bush may be recessed hemispherically to receive, in bearing engagement, a hemispherical end of a respective pin.

The or each hinge pin may be fixed to one of the leaf knuckles.

A pair of hinge pins may be provided each fixed to a respective leaf knuckle and having end-to-end bearing interengagement within one of said knuckles with face-to-face bearing engagement of the respective knuckles.

The hinge may a be lift-off hinge having a pair of leaf knuckles and a single pin non-removably located in one of said knuckles and extending into the other of said knuckles.

Two blind bushes may be provided fixedly located within respective axially aligned leaf knuckles, each receiving one end of a single hinge pin in bearing engagement therewith.

Embodiments of the invention will now be described, by way of example only, with reference to the accompanying drawings, in which:

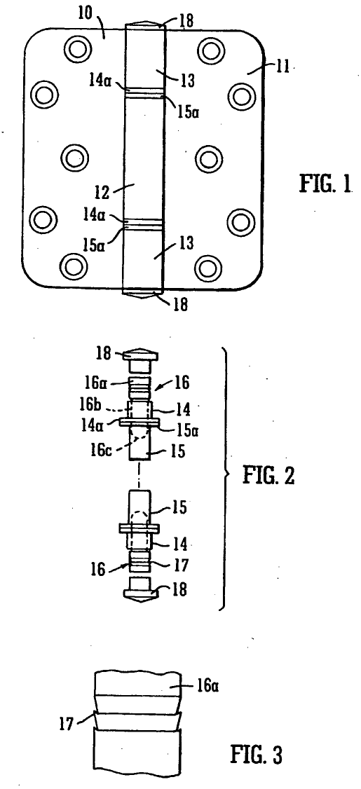

FIG. 1 is a front view of a single axis hinge;

FIG. 2 is an exploded view of part of the hinge of FIG. 1 to illustrate the mode of assembly thereof;

FIG. 3 is an enlarged view of a part of a hinge pin;

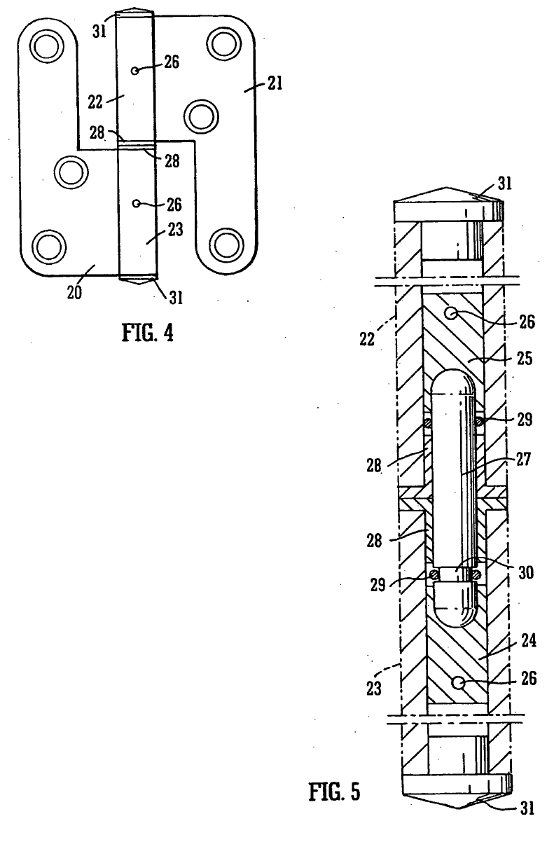

FIG. 4 is a front view of a lift-off hinge made in accordance with the invention;

FIG. 5 is an enlarged view of parts of the hinge of FIG. 4 showing the assembly thereof;

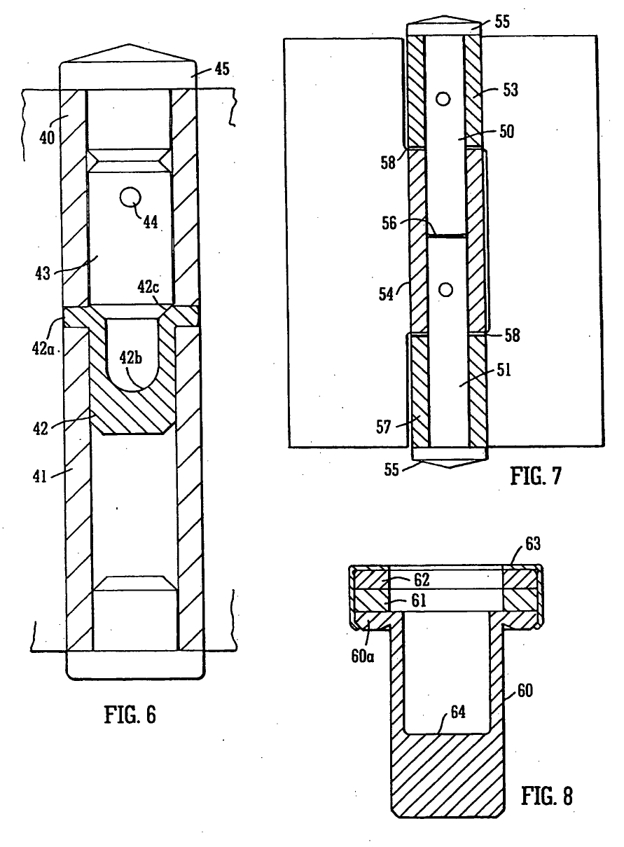

FIG. 6 is a view similar to FIG. 5 showing an alternative arrangement;

FIG. 7 is a view similar to FIGS. 5 and 6 showing a further alternative arrangement; and

FIG. 8 is an enlarged view of a bush which may form part of a hinge in accordance with the invention.

Referring now to FIGS. 1 to 3, a single axis hinge according to a first embodiment comprises a pair of leaves 10, 11 one having a male knuckle part 12 and the other having a pair of axially spaced female knuckle parts 13. The leaves are adapted to be secured by screws or rivets to an edge of a door and to an adjacent door frame respectively.

Between the axially aligned contra-rotating knuckle parts 12 and 13 is provided a first pair of bushes 14 each having a cylindrical part which is inserted into the adjacent end of the respective female knuckle part 13 and having a flange 14a which is thus located between the knuckle parts 13 and 12 respectively.

A pair of blind bushes 15 is inserted one into each end of the male knuckle part 12 with corresponding flanges 15a which are thus in face-to-face contra-rotating abutting relationship with the flanges 14a of bushes 14.

With the bushes 14 and 15 in place the two halves of the hinge may be brought together whereupon a pair of hinge pins 16 is inserted into the respective ends of the female knuckle parts 13, each pin 16 having a portion 16a of a diameter such as to be a tight push-fit within the interior of the respective knuckle part 13, and a reduced diameter portion 16b which is freely rotatable within respective bushes 14 and 15, a hemi-spherical end 16c of each pin being seated within a correspondingly hemispherical recess in the respective blind bush 15.

As can be seen from FIG. 3, the pins 16 have barbed circumferential surfaces 17 which ensure that the pins, when inserted and pushed into the hinge, automatically take up any clearances with manufacturing tolerances and provide a close assembled fit in the blind bushes. Thus, the pins are prevented from retracting from their respective knuckle parts 13. The assembly is completed by push-fit end caps 18 which close the outer ends of the knuckle parts 13.

If required, studs may be passed radially through the knuckle parts 13 into the larger diameter portions 16a of the pins to retain them closely in place and to provide firm bearing engagement between the corresponding hemispherical parts of the pins and the blind bushes.

Thus, it can be seen that when the hinge is operating the axial load placed upon the hinge by the weight of the door on its frame is borne partially by the hemispherical seating of the pins 16 in the blind bushes 15 and partially by the face-to-face contra-rotating faces of the flanges 14a and 15a. Thus the hinge is supported in part by the pins and in part by the knuckle joints.

Referring now to FIGS. 4 and 5 in a lift-off hinge having leaves 20 and 21 each has a respective axially aligned knuckle 22, 23 which knuckles have relative rotation in the operation of the hinge.

In this example, and particularly as shown in the enlarged illustration of FIG. 5, blind bushes 24 and 25 are inserted respectively into the knuckles 22 and 23 and pinned radially by studs 26 fixedly thereto. The blind bushes 24, 25 are recessed to present mutually opposed hemispherical bearing seats between which extends a single hinge pin 27 having correspondingly hemispherical ends. The pin is supported at the knuckle joint by a pair of inner flanged bushes 28 each inserted into one of the knuckles 22, 23.

In a lift-off hinge of this type it is important that the hinge pin be secured to what is to be the lower of the two knuckles such that when the door is lifted from the frame the pin is retained by the remaining hinge part. For this purpose, a pair of spring circlips 29 is located one in each of the knuckles 22, 23 between the blind bushes 24, 25 and the respective inner bushes 28. Having located a bush 28 in knuckle part 23 the pin 27 is introduced into the hinge and has a reduced diameter recess 30 into which the lower spring circlip 29 becomes located with the lower hemispherical end of the pin 27 seated in the hemispherical recess of the bush 24. Thereafter, with the pin protruding above the lower of the inner bushes 28, the other hinge part 21 and knuckle 22 is lowered onto the pin which thus passes through the upper spring circlip 29 to become seated in the hemispherical end of blind bush 25. The assembly is completed by insertion of end caps 31.

In this case also, as in the embodiment of FIGS. 1 to 3, the axial load applied to the hinge by the weight of the door is borne in part by the hemispherical seating of the pin 27 in the bushes 24 and 25, and in part by the contra-rotating face-to-face abutment of the flanged inner bushes 28 of the knuckle parts 22 and 23. The pin 27 is retained in the knuckle part 23 by the lower circlip 29 located in the recess 30.

A hinge of the type illustrated in FIGS. 4 and 5 may be supplied with the pin 27 separate so that the hinge may become “handed” as required by insertion of the recessed end of pin 27 into what is to be the lower of the knuckle parts 22, 23. Countersinking of the screw holes in the two leaves 29, 21 may need to be on both faces of the leaves.

Traditionally, so called ‘lift-off’ hinges are supplied with the pins fitted and are thereby handed i.e. LH or RH. The purpose of supplying the pin separately and the ability to determine the ‘handing’ on installation by insertion of a self locking hinge pin as illustrated is that stockists, distributors, door manufacturers and end users do not have to determine the required handing of the installation or hinge.

Referring now to FIG. 6 and particularly in the case of a hinge required for lighter duty, one of the blind bushes in the embodiment of FIGS. 1 to 3 may be omitted. In this case, in a pair of upper and lower knuckle parts 40 and 41, a single blind bush 42 with a hemispherical seat 42a is located in a lower knuckle part 41 and has a flange 42a which therefore presents an upper bearing surface to the knuckle part 40. A single hinge pin 43 is fixedly located at 44 into the knuckle part 40 and an end cap 45 completes the assembly. Thus, pin 43 rotates with the knuckle part 40 and bears against the hemispherical seat 42b of blind bush 42 while the load is simultaneously borne by the face-to-face abutment of knuckle part 40 with flange 42a.

The load bearing at the interface may be enhanced by countersinking the upper end of the recess in the bush 42 as shown at 42c and providing a corresponding tapered shoulder on the pin 43.

Referring now to FIG. 7, in a further example of the hinge illustrated in FIGS. 1 to 3, the blind bushes may be omitted and a pair of pins 50 and 51 may be located within and fixed respectively to a first female knuckle part 53 and a male knuckle part 54 with end caps 55. As can be seen, the pins 50 and 51 are in end-to-end abutting relationship within knuckle part 54, at 56 where they will partially bear the axial load of the hinge together with the face-to-face abutting relationship between the female knuckle parts 53 and 57 with the male knuckle part 54. Once again, between these knuckle parts there may be provided a washer or the like 58 to enhance the face-to-face abutment.

In all of the embodiments it is possible to pre-load the hinge by ensuring that the end-to-end and/or face-to-face abutting relationships of the respective parts are placed in close bearing relationship prior to fixing the respective parts and insertion of the end caps. In this way, it is ensured that there can be no vertical play between the parts after assembly so that the hinge cannot become sloppy in use as in the case of conventional hinges.

In order to enhance a smooth operation of the hinges, in accordance with the invention, all pins, bushes and knuckle parts may be pre-coated with a low friction, high wear resistant solid lubricant carbon material known by the trade mark GRAPHITIC and supplied by Teer Coatings Limited of Kidderminster, England. Such coatings have a graphitic microcrystalline structure which exhibits a high hardness, low friction and high wear resistance with a friction co-efficient of 0.05 to 0.09, depending upon the conditions of use.

Referring now to FIG. 8, the blind bushes 15, 42 in the embodiments of FIGS. 1 to 3 and 6 respectively may be in the form of a hardened steel bush 60 having a phosphor bronze washer 61 superimposed over the flange 60a and itself superimposed by a hardened bearing steel washer 62, all encased by a stainless steel casing 63 recessed centrally to receive the hinge pin. In this example, the recess of the bush 60 is shown having a flat bearing seat 64 although it may be hemispherically formed as in the previous embodiments. Also, in this example, the respective bearing surfaces need not be lubricant coated.

1. A single axis hinge comprising a pair of leaves one for attachment to a door and the other to a door frame upon which the door is to be hung, the leaves having respective tubular knuckles which are axially aligned in the assembled hinge and which receive at least one hinge pin forming a pivotal journal between the respective knuckles; characterized in that the assembly of the or each pin and the knuckles is such that an axial load applied to the hinge where the door is hung thereon is supported in part by the or each hinge pin and in part by a face-to-face abutment of the leaf knuckles.

2. A single axis hinge according to claim 1 including at least one annular bush interposed between abutting faces of the leaf knuckles.

3. A single axis hinge according to claim 2 wherein the or each bush has a cylindrical part to be inserted into at least one of the leaf knuckles.

4. A single axis hinge according to claim 2 wherein the bush is a blind bush recessed axially to provide a seat for an end of a hinge pin.

5. A single axis hinge according to claim 4 wherein the bush is recessed hemispherically to receive, in bearing engagement, a hemispherical end of a respective pin.

6. A single axis hinge according to claim 1 wherein the or each hinge pin is fixed to one of the leaf knuckles.

7. A single hinge pin according to claim 1 including a pair of hinge pins each fixed to a respective leaf knuckle and having end-to-end bearing interengagement within one of said knuckles with face-to-face bearing engagement of the respective knuckles.

8. A single axis hinge according to claim 1, being formed as a liftoff hinge having a pair of leaf knuckles and a single pin non-removably located in one of said knuckles and extending into the other said knuckles.

9. A single axis hinge according to claim 1 including two blind bushes fixedly located within respective axially aligned leaf knuckles, each receiving one end of a single hinge pin in bearing engagement therewith.

10. A single axis hinge according to claim 1 wherein the or each hinge pin including means to ensure that the pins, when inserted and pushed into the hinge, automatically take up any clearances with manufacturing tolerances and provide a close assembled fit in the blind bushes whereby the or each hinge pin is prevented from retracting from its respective knuckle part.

11. A single axis hinge according to claim 1 wherein the or each hinge pin is fixed to and within a respected knuckle part by at least one stud passed radially through the knuckle part and into the pin.

12. A single axis hinge according to claim 4 wherein the blind bush is countersunk and the or each hinge pin has a corresponding tapered shoulder to bear against the countersunk part of the bush in the assembled hinge.

13. A single axis hinge according to claim 2 wherein the interengaging faces of the leaf knuckles, the or each pin, and the or each annular bush, are coated with a low-friction, high wear resistant solid lubricant carbon material having a graphitic microcrystalline structure and a friction coefficient of between 0.05 and 0.09.
